(19) United States
(12) Patent Application Publication
(10) Pub. No.: US 2008/0196972 A1
(43) Pub. Date: Aug. 21, 2008

(54) Integrated Multiple-Section Climbing Apparatus

(76) Inventor: Jody Bell, Warm Springs, GA (US)

Correspondence Address: Robert A. Blaha;SMITH FROHWEIN TEMPEL GREENLEE BLAHA LLC, Suite 700, Two Ravinia Drive, Atlanta, GA, 30346, US

(21) Appl. No.: 12/031,057

(22) Filed: Feb. 14, 2008

Related U.S. Application Data
(60) Provisional application No. 60/890,249, filed on Feb. 16, 2007.

(51) Int. Cl. E06C 1/34

(52) U.S. Cl. 182/92; 182/136

(57) ABSTRACT

A climbing apparatus includes a first stile, a second stile and a base member. The first stile has a base end and a second end. The base end has a slot. The base member is coupled to the base end of the first stile such that the base member can pivot about an axis substantially orthogonal to the longitudinal axis of the first stile. The second stile has a first end and a distal end. The first end is coupled to the second end of the first stile via a hinge.

### CROSS REFERENCE TO RELATED APPLICATION

This application claims priority to co-pending U.S. provisional application entitled, “Integrated Multiple-Section Climbing Apparatus,” having Ser. No. 60/890,249, filed on Feb. 16, 2007, and which is entirely incorporated herein by reference.

### BACKGROUND

It is desirable in many situations to hunt game from above the ground. Many deer hunters use tree stands to locate themselves above the ground. Hunting from above ground provides several advantages, such as remaining above a deer's normal field of view, raising human and other scents above a deer's nose, and increasing a hunter's range of vision.

In many cases, hunters will visit an area before the start of the local deer season to locate and monitor deer activity. Hunters often have to walk significant distances to reach desirable areas to hunt. Consequently, deer hunters often have to walk long distances carrying both a stand and a ladder or other tools that will enable the hunter to climb a suitable height above the ground in a tree that will safely support the stand.

A number of prior art devices have been devised to assist hunters in placing or reaching a previously placed deer stand. For example, some hunters use tree spikes or strap-on steps to ascend the tree. Others use multiple-segment climbing sticks or multiple-segment ladders to scale the tree.

The use of tree spikes not only damages the tree but requires the hunter to carry a hammer to drive the tree spike into the trunk of the tree. As a result, the use of tree spikes requires that the hunter carry extra weight to and from the hunting area.

Strap-on steps, are subject to slipping and require the hunter to secure a strap around the tree at each step. This makes initial placement difficult and time consuming when the tree does not have branches that can be used for balance and support.

Climbing sticks include multiple segments each having alternating foot/hand holds on opposing sides of a shaft. A base segment includes a first end with a fixed lateral support and an upper end that is crimped or otherwise shaped to be inserted within a receiving end of the next segment. Intermediate segments include a receiving end and an opposing crimped end. An uppermost segment includes a receiving end for receiving the adjacent segment's crimped end. Multiple-segment climbing sticks are generally made of steel. As a result, a multiple-segment climbing stick can weigh between 25 to 30 lbs. Brackets arranged to rest on the trunk of a tree as well as the foot/hand holds are fixed to a center shaft in arrangements that do not permit compact storage and easy transport to the hunting area.

Multiple-segment ladders suffer from similar deficiencies as those encountered with climbing sticks. For example, the fixed lateral support of the base segment of a climbing stick and the base section of a multiple-segment ladder are not suited for uneven ground. When the base segment of a climbing stick or the base section of a multiple-section ladder is placed on uneven ground and only one end of the lateral support or one stile of the ladder contacts the ground or a root of the tree, the upper end of the base segment and any connected segments of the ladder rotate away from the tree in the opposite direction of the supported end of the base section. In addition, climbing sticks and multiple-segment ladders provided by different manufacturers are made with unique mating configurations such that segments from one manufacturer do not mate with segments from another manufacturer. Thus, a hunter that uses a climbing stick or multiple-segment ladder must keep track of each of the mating segments and the mounting straps for each unit.

Thus, a heretofore unaddressed need exists in the industry to address the aforementioned deficiencies and inadequacies.

### SUMMARY

An integrated multiple-section climbing apparatus includes a base member that is coupled to a stile via a pin. The pin permits the base member to pivot about the axis of the pin such that opposing ends of the base member can rest on the ground or a tree root while the apparatus is placed in a generally upright position against a tree. The apparatus includes multiple sections or stiles that are coupled to one another by a hinge. Each of the hinges has a respective latch that enables adjacent stiles on opposing ends of each hinge to be arranged substantially above/below the other when in a locked position. In a transport/storage position, adjacent stiles rest against one another. Each of the stiles includes foot/hand holds on alternating sides that protrude in a direction that is substantially orthogonal to the longitudinal axis of the respective stile. Foot/hand holds are each arranged with an upright catch that prevents a hunter from slipping off the unsupported end of the foot/hand hold. A carrying strap is coupled to one of the stiles. Mounting straps can be used to secure the stiles to one another when the multiple-section climbing apparatus is in a transport or storage position. The base member, stiles, foot/hand holds and uprights can be constructed of aluminum. Consequently, a multiple-section climbing apparatus provides an easily transportable and readily configurable climbing tool that enables a hunter to safely place, access and egress a tree stand.

An embodiment of a climbing apparatus includes a first stile having a base end and a second end, the base end arranged with a slot, a base member coupled to the first stile proximal to the base end such that the base member can pivot about an axis substantially orthogonal to a longitudinal axis of the first stile and a second stile having a first end and a distal end, the first end coupled to the second end of the first stile via a hinge.

An embodiment of a method for constructing a climbing apparatus includes the steps of coupling a base member to a first stile such that the base member can pivot about an axis substantially orthogonal to the longitudinal axis of the first stile, integrating a second stile at an end of the first stile opposing the base member, integrating a third stile at an end of the second stile opposing the first stile, integrating a fourth stile at an end of the third stile opposing the second stile, arranging each of the first stile, second stile, third stile and fourth stile with alternating transverse members extending from and substantially orthogonal to the respective stile, wherein integrating the second stile, third stile and fourth stile comprises using respective hinges.

An embodiment of a method for adjusting a climbing apparatus includes the steps of placing a pivotably coupled base member in contact with a surface, using a first hinge at an opposing end of a first stile coupled to the base member to arrange a second stile in substantial vertical alignment with the first stile above the base member, using a second hinge to arrange a third stile in substantial vertical alignment with the first stile and the second stile, using a third hinge to arrange a fourth stile in substantial vertical alignment with the first stile, second stile and third stile and arranging an adjustable strap coupled to at least one of the first stile, the second stile, the third stile and the fourth stile such that the adjustable strap encompasses a mounting surface and causes the corresponding stile to contact the mounting surface.

Other devices, methods, features and advantages will be or will become apparent to one skilled in the art upon examination of the following figures and detailed description. All such additional devices, methods, features and advantages are defined and protected by the accompanying claims.

The integrated multiple-section climbing apparatus and methods for constructing and using the same, as defined in the claims, can be better understood with reference to the following drawings. The components within the drawings are not necessarily to scale relative to each other; emphasis instead is placed upon clearly illustrating the principles involved.

### BRIEF DESCRIPTION OF THE FIGURES

FIG. 1 is a schematic diagram illustrating an embodiment of a climbing apparatus in an extended position.

FIG. 2 is a side view of the climbing apparatus of FIG. 1.

FIGS. 3A and 3B are schematic diagrams illustrating the climbing apparatus of FIGS. 1 & 2 in a storage position.

FIG. 4 is flow diagram illustrating an embodiment of a method for constructing the climbing apparatus of FIG. 1.

FIG. 5 is a flow diagram illustrating an embodiment of a method for adjusting the climbing apparatus of FIG. 1.

### DETAILED DESCRIPTION

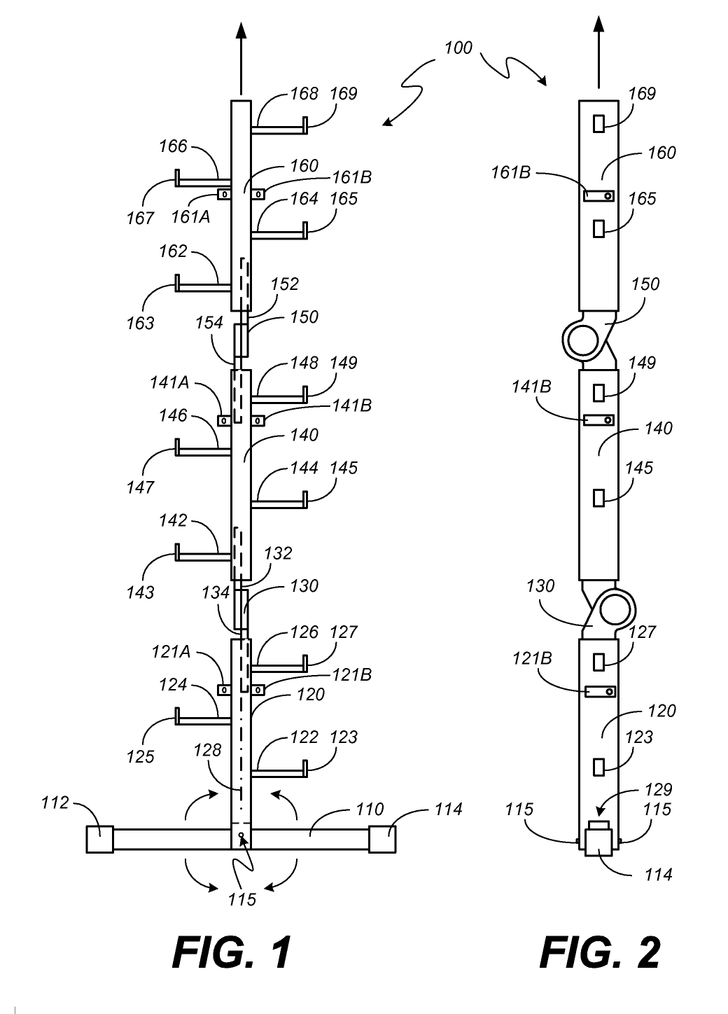

FIG. 1 is a schematic diagram illustrating a front view of an embodiment of the climbing apparatus 100 in an upright or extended position. Apparatus 100 includes base member 110, first stile 120, second stile 140 and third stile 160. Base ember 110 is pivotably connected to a first stile 120. Second stile 140 is connected to the opposing end of first stile 120 at a first end and third stile 130 at a second end. An additional stile or stiles (not shown) can be similarly coupled to extend apparatus 100 to desired lengths.

First stile 120 is arranged with a slot 129 at a first end for receiving base member 110. Base member 110 is coupled to first stile 120 via a pin 115 that enables base member 110 to pivot along an axis that is substantially orthogonal to the longitudinal axis 128 of first stile 120. Base member 110 is arranged with cap 112 and cap 114. Cap 112 and cap 114 are constructed of a pliable material that provides strength and a non-slip support. Base member 110 pivots to accommodate uneven ground often encountered in the vicinity of the base of a tree. In some embodiments (not shown), cap 112 and cap 114 are configured in various shapes so that base member 110 can avoid contact with tree roots, rocks or other obstacles near the trunk of a tree.

First stile 120 is coupled at an opposing end to second stile 140 via hinge 130. Hinge 130 includes first arm 132 and second arm 134. First arm 132 extends into a recess formed by the interior surfaces of second stile 140. Second arm 134 extends into a recess formed by the interior surfaces of first stile 120. First arm 132 and second arm 134 can be riveted or otherwise connected to opposing surfaces of second stile 140 and first stile 120, respectively.

Alternating foot/hand holds (e.g., member 122) extend from first stile 120 in a direction that is substantially orthogonal to longitudinal axis 128. Member 122 and member 126, separated from each other along a desired portion of the height of first stile 120, extend in a rightward direction from first stile 120. Upright 123 is coupled at the distal end of member 122. Upright 127 is coupled to the distal end of member 126. Upright 123 and upright 127 prevent a climber from having a foot or hand slip off the distal end of the corresponding member. Member 124 disposed between member 122 and member 126 extends in a leftward direction from first stile 120. Upright 125 is coupled at the distal end of member 124. Upright 125 prevents a climber from having a foot or hand slip off the distal end of member 124.

Bracket 121A connected to the leftward facing side of first stile 120, includes a slot for receiving a connector such as an S-shaped hook connected to one end of an adjustable strap (not shown). Bracket 121B connected to the rightward facing side of first stile 120, includes a slot for receiving a connector such as a second S-shaped hook connected to an opposing end of the adjustable strap.

Second stile 140 is further coupled to third stile 160 via hinge 150. Hinge 150 includes first arm 152 and second arm 154. First arm 152 extends into a recess formed by the interior surfaces of third stile 160. Second arm 154 extends into a recess formed by the interior surfaces of second stile 140. First arm 152 and second arm 154 can be riveted or otherwise connected to opposing surfaces of third stile 160 and second stile 140, respectively.

Alternating foot/hand holds (e.g., member 142) extend from second stile 140 in a direction that is substantially orthogonal to longitudinal axis 128. Member 144 and member 148, separated from each other along a desired portion of the height of second stile 140, extend in a rightward direction from second stile 140. Upright 145 is coupled at the distal end of member 144. Upright 149 is coupled to the distal end of member 148. Upright 145 and upright 149 prevent a climber from having a foot or hand slip off the distal end of the corresponding member. Member 142 and member 146, separated from each other along a desired portion of the height of second stile 140, extend in a leftward direction from second stile 140. Upright 143 is coupled at the distal end of member 142. Upright 147 is coupled to the distal end of member 146. Upright 143 and upright 147 prevent a climber from having a foot or hand slip off the distal end of the corresponding member.

Bracket 141A connected to the leftward facing side of second stile 140, includes a slot for receiving a connector such as an S-shaped hook connected to one end of an adjustable strap (not shown). Bracket 141B connected to the rightward facing side of second stile 140, includes a slot for receiving a connector such as a second S-shaped hook connected to an opposing end of the adjustable strap.

Alternating foot/hand holds (e.g., member 162) extend from third stile 160 in a direction that is substantially orthogonal to longitudinal axis 128. Member 164 and member 168, separated from each other along a desired portion of the height of third stile 160, extend in a rightward direction from third stile 160. Upright 165 is coupled at the distal end of member 164. Upright 169 is coupled to the distal end of member 168. Upright 165 and upright 169 prevent a climber from having a foot or hand slip off the distal end of the corresponding member. Member 162 and member 166, separated from each other along a desired portion of the height of third stile 160, extend in a leftward direction from third stile 160. Upright 163 is coupled at the distal end of member 162. Upright 167 is coupled to the distal end of member 166. Upright 163 and upright 167 prevent a climber from having a foot or hand slip off the distal end of the corresponding member.

Bracket 161A connected to the leftward facing side of third stile 160, includes a slot for receiving a connector such as an S-shaped hook connected to one end of an adjustable strap (not shown). Bracket 161B connected to the rightward facing side of third stile 160, includes a slot for receiving a connector such as a second S-shaped hook connected to an opposing end of the adjustable strap.

FIG. 2 is a side view of the climbing apparatus 100 of FIG. 1. FIG. 2 illustrates features of climbing apparatus 100 as may be observed from the right side of the apparatus as arranged in FIG. 1. As shown in FIG. 2, each of hinge 130 and hinge 150 are extended to a position such that the corresponding arms form an angle of approximately 180°. Hinge 130 is arranged such that first stile 120 and second stile 140 can be rotated to the right. Hinge 150 is arranged in an opposing position such that third stile 160 can be rotated toward the left.

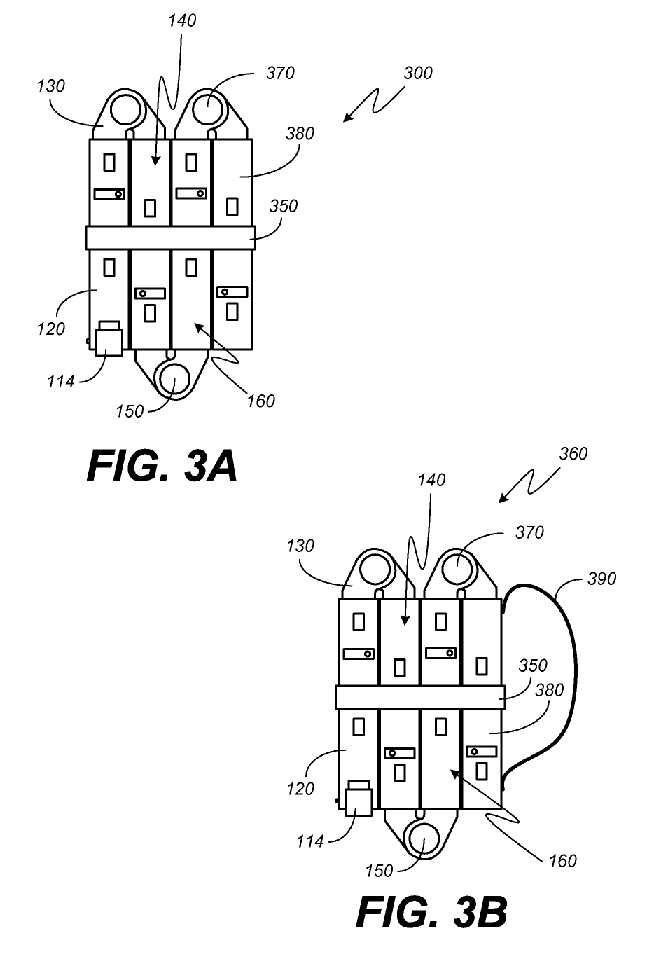

FIGS. 3A and 3B are schematic diagrams illustrating an alternative embodiment of the climbing apparatus of FIGS. 1 & 2 in a transport or storage configuration. As illustrated in FIG. 3A, climbing apparatus 300 is manipulated into a relatively compact configuration by rotating each of hinge 130, hinge 150 and hinge 370 approximately 180° such that first stile 120 is in close arrangement with second stile 140 and such that third stile 160 is in close arrangement with second stile 140 and a fourth stile 380. One or more adjustable straps 350 are wrapped around the exterior surfaces of the stiles both for holding the apparatus 300 in the transport or storage configuration and for convenience. Preferably, at least one adjustable strap 350 is provided for each stile or section of the apparatus 300. The adjustable straps can be configured with the above-described S-hooks or other suitable connectors for securing the strap to corresponding brackets (e.g., bracket 121A and bracket 121B) on stile. The adjustable straps are further configured in sections that are separated by a ratchet mechanism or a similar device to pull apparatus 300 in close contact with a tree when the strap is connected to the brackets and wrapped around the circumference of a tree.

FIG. 3B shows a carrying strap 390 connected along an exterior surface of fourth stile 380. Alternatively, carrying strap 390 can be connected to an exterior surface of first stile 120. In either configuration, apparatus 360 can be more easily carried to a desirable tree for observing or hunting game such as deer.

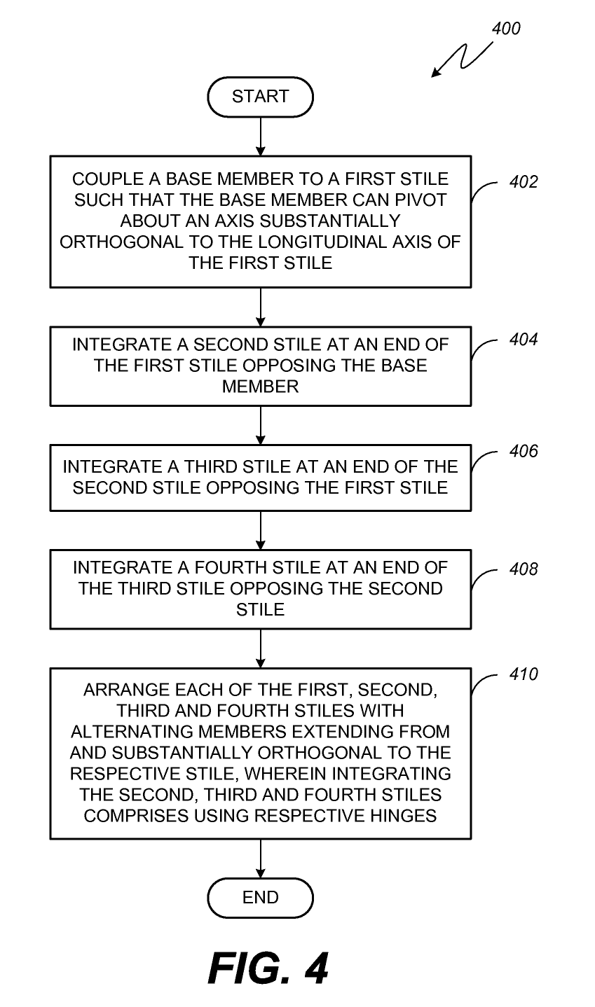

FIG. 4 is flow diagram illustrating an embodiment of a method for constructing the climbing apparatus of FIG. 1. Method 400 begins with block 402 where a base member is coupled to a first stile such that the base member can pivot about an axis substantially orthogonal to the longitudinal axis of the first stile. In block 404, a second stile is integrated to the remaining end of the first stile. In block 406, a third stile is integrated to the remaining end of the second stile. In block 408, a fourth stile is integrated to the remaining end of the third stile. In block 410, each of the stiles are arranged with members extending from opposing sides of the respective stile. As further illustrated in block 410, integrating each of the second, third and fourth stiles is accomplished using respective hinges to connect adjacent stiles.

It should be understood, that the separate steps associated in each of blocks 402 through 410 need not be performed in the illustrated sequence. In fact, the climbing apparatus can be constructed using many variations of the above-described steps. For example, assembly can be accomplished by starting with what will ultimately be the uppermost stile in the series of stiles and integrating hinges and stiles until the apparatus includes a desired number of stiles before adding the base member. By way of further example, assembly can be accomplished by selecting an intermediate stile, connecting hinges in respective ends of the stile and connecting additional stiles to the hinges.

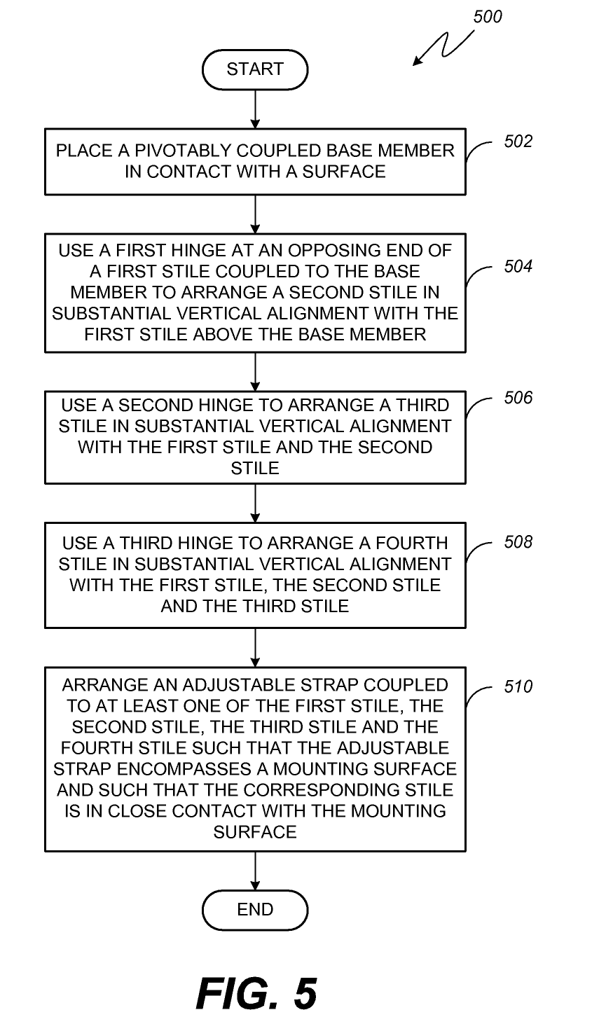

FIG. 5 is a flow diagram illustrating an embodiment of a method for adjusting the climbing apparatus of FIG. 1. Method 500 begins with block 502 where a base member is placed in contact with a surface. In block 504, a first hinge at an opposing end of a first stile connected to the base member is used to arrange a second stile in substantial vertical alignment with the first stile above the base member. In block 506, a second hinge is used to arrange a third stile in substantial vertical alignment with the first stile and the second stile. In block 508, a third hinge is used to arrange a fourth stile in substantial vertical alignment with the first, second and third stiles. In block 510, an adjustable strap coupled to at least one of the stiles is arranged to encompass a mounting surface such that the corresponding stile is in close contact with the mounting surface.

The foregoing description has been presented for purposes of illustration and description. It is not intended to be exhaustive or to limit the scope of the multiple-section climbing apparatus to the precise forms disclosed. Modifications or variations are possible in light of the above teachings. The embodiments discussed, however, were chosen and described to enable one of ordinary skill to utilize various embodiments of the present apparatus and methods. All such modifications and variations are within the scope of the appended claims when interpreted in accordance with the breadth to which they are fairly and legally entitled.

What is claimed is:

1. A climbing apparatus, comprising:
a first stile having a base end and a second end, the base end arranged with a slot;
a base member coupled to the first stile proximal to the base end such that the base member can pivot about an axis substantially orthogonal to a longitudinal axis of the first stile; and
a second stile having a first end and a distal end, the first end coupled to the second end of the first stile via a first hinge.

2. The climbing apparatus of claim 1, wherein the first hinge comprises a detent position that aligns the first and second stiles along the longitudinal axis of both the first stile and the second stile.

3. The climbing apparatus of claim 1, wherein the hinge comprises a first arm coupled to an interior surface of the first stile and a second arm coupled to an interior surface of the second stile.

4. The climbing apparatus of claim 1, wherein the first stile and the second stile have a member that extends from the surface of the stile in the same plane as the longitudinal axis of the base member.

5. The climbing apparatus of claim 4, wherein the member has an upright coupled to an end of the member removed from the respective stile.

6. The climbing apparatus of claim 1, wherein the base member is coupled to the first stile via a pin.

7. The climbing apparatus of claim 1, wherein each of the first stile and the second stile comprise a bracket arranged to permit the first stile and the second stile to be fastened to a tree.

8. The climbing apparatus of claim 7, further comprising an adjustable strap for holding the first stile and the second stile in contact with the other in when the climbing apparatus is in a storage or transport configuration and for fastening one of the first stile or the second stile to a tree via a respective bracket when the climbing apparatus is in use.

9. The climbing apparatus of claim 1, wherein the hinge enables the first stile and the second stile to be folded against the other.

10. The climbing apparatus of claim 1, further comprising a third stile having a first end and a distal end, the first end coupled to the distal end of the second stile via a second hinge.

11. The climbing apparatus of claim 10, further comprising a fourth stile having a first end and a distal end, the first end coupled to the distal end of the third stile via a third hinge.

12. The climbing apparatus of claim 10, further comprising a carrying strap coupled to the fourth stile.

13. The climbing apparatus of claim 11, wherein the first hinge and the third hinge open and close by relative rotation of the first and second stiles and relative rotation of the third and fourth stiles in the same directions.

14. The climbing apparatus of claim 13, wherein the second hinge opens and closes by relative rotation of the second stile and the third stile in the opposite directions of those used by the first hinge and the third hinge.

15. A method for constructing a climbing apparatus, comprising:
coupling a base member to a first stile such that the base member can pivot about an axis substantially orthogonal to the longitudinal axis of the first stile;
integrating a second stile at an end of the first stile opposing the base member;
integrating a third stile at an end of the second stile opposing the first stile;
integrating a fourth stile at an end of the third stile opposing the second stile;
arranging each of the first stile, second stile, third stile and fourth stile with alternating transverse members extending from and substantially orthogonal to the respective stile, wherein integrating the second, third and fourth stile comprises using respective hinges.

16. The method of claim 15, wherein coupling comprises inserting a pin.

17. The method of claim 15, wherein integrating the second, third and fourth stile comprises alternating the position of adjacent hinges.

18. The method of claim 15, further comprising applying a camouflage paint scheme to the external surfaces of the climbing apparatus.

19. A method for preparing a climbing apparatus, comprising:
placing a pivotably coupled base member in contact with a surface;
using a first hinge at an opposing end of a first stile coupled to the base member to arrange a second stile in substantial vertical alignment with the first stile above the base member;
using a second hinge to arrange a third stile in substantial vertical alignment with the first stile and the second stile;
using a third hinge to arrange a fourth stile in substantial vertical alignment with the first stile, second stile and third stile; and
arranging an adjustable strap coupled to at least one of the first stile, the second stile, the third stile and the fourth stile such that the adjustable strap encompasses a mounting surface and causes the corresponding stile to contact the mounting surface.

20. The method of claim 19, wherein using a first hinge to arrange a second stile in substantial vertical alignment with the first stile and using a third hinge to arrange a fourth stile in substantial vertical alignment with the first stile, second stile and third stile comprises rotating the first hinge and the third hinge in the same direction.
